(19) United States
(12) Patent Application Publication
(10) Pub. No.: US 2008/0083591 A1
(43) Pub. Date: Apr. 10, 2008

(54) Device for Damping Vibrations

(75) Inventors: Jurgen Berghus, Simmozheim (DE); Jurgen Weissinger, Bissingen (DE); Thomas Wergula, Leonberg (DE)

Correspondence Address: FITCH, EVEN, TABIN & FLANNERY, P. O. BOX 18415, WASHINGTON, DC, 20036, US

(73) Assignee: DaimlerChryster AG, Stuttgart (DE)

(21) Appl. No.: 11/632,185

(22) PCT Filed: Jul. 6, 2005
(86) PCT No.: PCT/EP05/07267

§ 371 Date: Mar. 28, 2007

(30) Foreign Application Priority Data
Jul. 17, 2004 (DE) 10 2004 034 567.8

(51) Int. Cl. F16F 7/104

(52) U.S. Cl. 188/379

(57) ABSTRACT

A device for damping vibrations in a motor vehicle is proposed, having a structure (3) and a wheel carrier (1) which supports a wheel (2) and is connected to the structure (3) in an articulated fashion by means of links (4, 5).

According to the invention, it is provided in the device for damping vibrations according to the invention that a coupling element (13) is arranged between one of the links (4, 5) and the assembly (8).

Use in motor vehicles, in particular passenger vehicles.

The invention relates to a device for damping vibrations in a motor vehicle as per the preamble of claim 1.

A device on a chassis auxiliary frame is known from the laid-open specification DE 102 44 361 A1, which device provides a coupling between a chassis auxiliary frame and a mount of a spring-and-damper strut or a damper. As a result, the chassis auxiliary frame is held in a substantially fixed fashion, and does not move counter to the compression direction of a wheel. This avoids vibration stimulation of assemblies and components mounted on the chassis auxiliary frame mount.

It is an object of the invention in contrast to this to provide a device which can be used with all axle designs to effectively damp vibrations of assemblies.

Said object is achieved by means of a device having the features of claim 1.

The device according to the invention is distinguished by a coupling element arranged between a link and an assembly, A wheel carrier which supports a wheel is guided by means of links which are connected to the structure in an articulated fashion. A spring element which is arranged between the link and the structure allows the wheel Co compress for example when driving over an uneven surface. The spring element is preferably embodied as a coil spring, torsion spring or air spring. As the wheel compresses and rebounds, the links likewise move relative to the structure. The term “assembly” comprises, for example, the drive engine with all the associated auxiliary units, the transmission for setting different transmission ratios, the transfer box for all-wheel drive, the steering gear and/or differentials. In the event of fast compression, an impulse, that is to say an impetus, is exerted on the structure, and the structure likewise rises proportionately as well as the wheel. As a result of inertial forces, the spring elements which serve to mount the assembly on the structure are compressed, and the assembly is stimulated to vibrate. The coupling element with the associated connecting points can be designed to be rigid with regard to compression and/or tension or to be resilient with regard to compression and/or tension. In the same way, the coupling element can for example comprise a device which transmits forces by means of friction or hydraulics. In addition, the coupling element can also comprise a plurality of individual parts which are connected to one another by means of linkages or mechanism devices. The coupling element connected to one of the links exerts an impulse on the assembly as a result of the movement of the links, which impulse prevents or at least reduces the compression of the spring elements, so that a stimulus to vibrate is advantageously avoided.

In one embodiment of the invention, the structure comprises a support, on which the assembly is mounted, and a body. Mounts for resiliently connecting the assembly are provided on the support. The support conducts forces uniformly into the body, so that little deformation occurs.

In one embodiment of the invention, the support is connected to the body in an immoveable manner. The support is embodied as an integral support which is fastened to the structure. The integral support serves to hold a drivetrain and to hold the steering system and a front axle arrangement. The integral support can be connected to the body by means of a welding, soldering or adhesive process. Said connection can likewise be provided by means of a detachable connection, for example by means of screws. The use of an integral support increases the stability of the structure.

In a further embodiment of the invention, the support is connected to the body by means of mounts. The support is embodied as a chassis auxiliary frame on which assemblies of the drivetrain and steering components and parts of the axle suspension are mounted. The chassis auxiliary frame itself is connected to the body by means of resilient mounts. This advantageously has the result that vibrations stimulated by the underlying surface and by the drivetrain are decoupled from the body.

In a further embodiment of the invention, the coupling element is embodied as a rigid rod. The rigid rod is arranged in an articulated manner both on one of the links and on the assembly. The device according to the invention can be cost-effectively formed by a rigid rod.

In a further embodiment of the invention, the coupling element is embodied as a vibration damper. Vibration dampers convert vibration energy into heat through friction. The coupling element can, for example, be embodied as an oil-filled telescopic damper. The telescopic vibration damper transmits a force, which is dependent on the speed of compression of the wheel, to the assembly. It is advantageously possible by changing the characteristic curve of the vibration damper and its mounting to adapt the device so as to provide effective vibration damping.

In a further embodiment of the invention, the coupling element is connected to a link which is mounted on the body. For example, an upper triangular link of a wheel suspension arrangement is mounted between the wheel carrier and the body. A coupling element is mounted in each case in an articulated manner on said link and on the assembly. Movements of the link can advantageously be transmitted to the assembly in such a way that a stimulus for the assembly to vibrate is limited or eliminated. Said arrangement also makes it possible to utilize the installation space in the region of the body for the coupling element.

In a further embodiment of the invention, the coupling element is connected to a link which is mounted on the support. A lower triangular link of a wheel suspension arrangement is mounted between the wheel carrier and the body. The coupling element is arranged between the triangular link and the assembly, and reduces a stimulus for the assembly to vibrate during compression and rebound of the wheel.

In a further embodiment of the invention, the coupling element is connected to a link which is embodied as a stabilizer rod. Stabilizer rods are preferably torsion elements which are composed of a torsion bar arranged transversely with respect to the direction of travel and two limbs which are linked to the lower and upper transverse links or to the wheel carrier. As the wheel compresses, the torsion bar is twisted. A connecting point for the coupling element is to be provided on the torsion bar, in the form of a section which is bent out at right angles or a lever which is welded on. The connecting point then moves upward and downward with the wheel as the latter compresses and rebounds. The coupling element arranged between the connecting point and the assembly thereby exerts an impulse on the assembly, as a result of which it is possible for vibration of the assembly to be eliminated or at least limited. In the same way, the coupling element can also be connected to the limbs of the stabilizer rod. Connecting the coupling element to the stabilizer rod frees up further installation positions, making it possible to better utilize the installation space.

In a further embodiment of the invention, the coupling element exerts a force on the assembly in the direction of the vehicle vertical axis during movements of the link. A vertical axis z, a longitudinal axis x and a transverse axis y are defined on the basis of a coordinate system at the center of gravity of the vehicle. As the wheel compresses or rebounds, the links are moved with it. The coupling element is arranged such that a force acts on the assembly in the vehicle vertical axis during movements of the links. Depending on the direction of movement of the link, the force is a tensile or compressive force, that is to say the force acts in both directions of the vertical axis. If the central axis of the coupling element runs parallel to the vertical axis, then a force component acts on the assembly in the direction of the vertical axis during movements of the link. Vibrations of the assembly in the vertical axis are considerably reduced by means of the device according to the invention.

In a further embodiment of the invention, the coupling element exerts a force on the assembly in the direction of the longitudinal axis during movements of the link. If the coupling element lies in a plane which encloses an angle other than 90° with the longitudinal axis, then the coupling element exerts a force on the assembly in the direction of the longitudinal axis during movements of the link. Said force acts in both directions of the longitudinal axis, depending on whether the wheel compresses or rebounds. Said arrangement makes it possible to avoid longitudinal vibrations of the assembly caused by vibration stimulus from the underlying surface.

In a further embodiment of the invention, the coupling element exerts a force on the assembly in the direction of the transverse axis during movements of the link. If the coupling element lies in a plane which is perpendicular to the longitudinal axis and the central axis of the coupling element does not run parallel to the vertical axis, then a force component acts on the assembly in the direction of the transverse axis. The force component in the direction of the transverse axis is equalized if the wheels of an axle compress or rebound simultaneously, since said force acts on both sides of the assembly. If, however, one wheel compresses, then a stimulus for the assembly to vibrate is eliminated or at least reduced by an impulse of the coupling element on the assembly in the transverse direction. The impulse components of the coupling element in the longitudinal, transverse and vertical axes of the vehicle can be determined by the spatial arrangement of the coupling element.

In a further embodiment of the invention, the longitudinal axis of the coupling element runs through the center of gravity of the assembly. This arrangement avoids a rotational impulse, which would lead to additional loading of the engine mounts, by means of the impulse exerted by the coupling element on the assembly.

Further features and combinations of features can be gathered from the description and the drawings. Concrete exemplary embodiments of the invention are illustrated in simplified form in the drawings and are explained in more detail in the following description.

In the drawings:

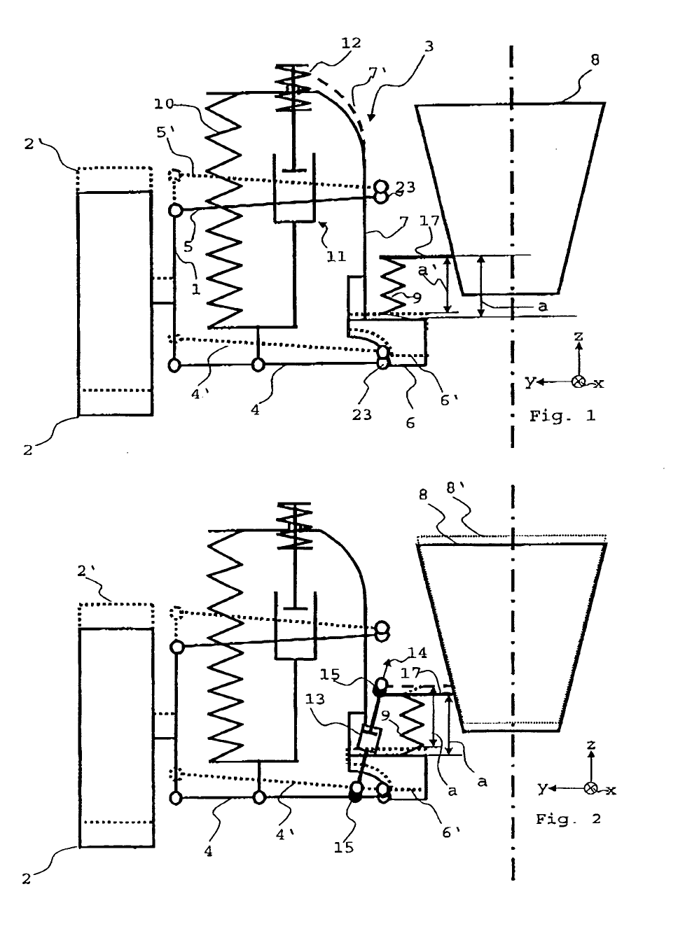

FIG. 1 is a schematic illustration of a wheel suspension arrangement,

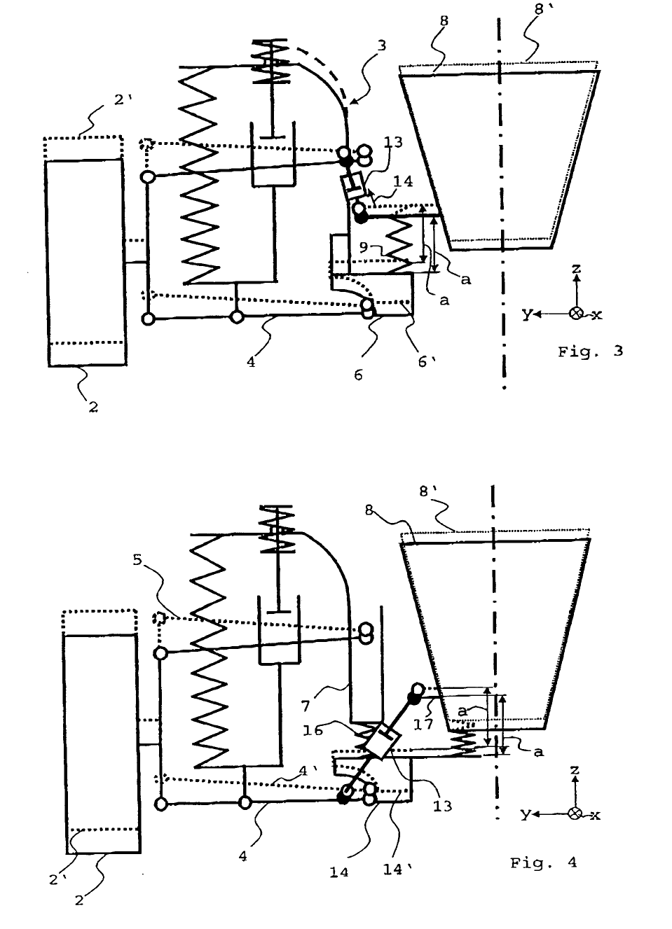

FIG. 2 is a schematic illustration of a wheel suspension arrangement as per FIG. 1 with a device according to the invention,

FIG. 3 is a schematic illustration of a wheel suspension arrangement as per FIG. 1 with a second embodiment of a device according to the invention,

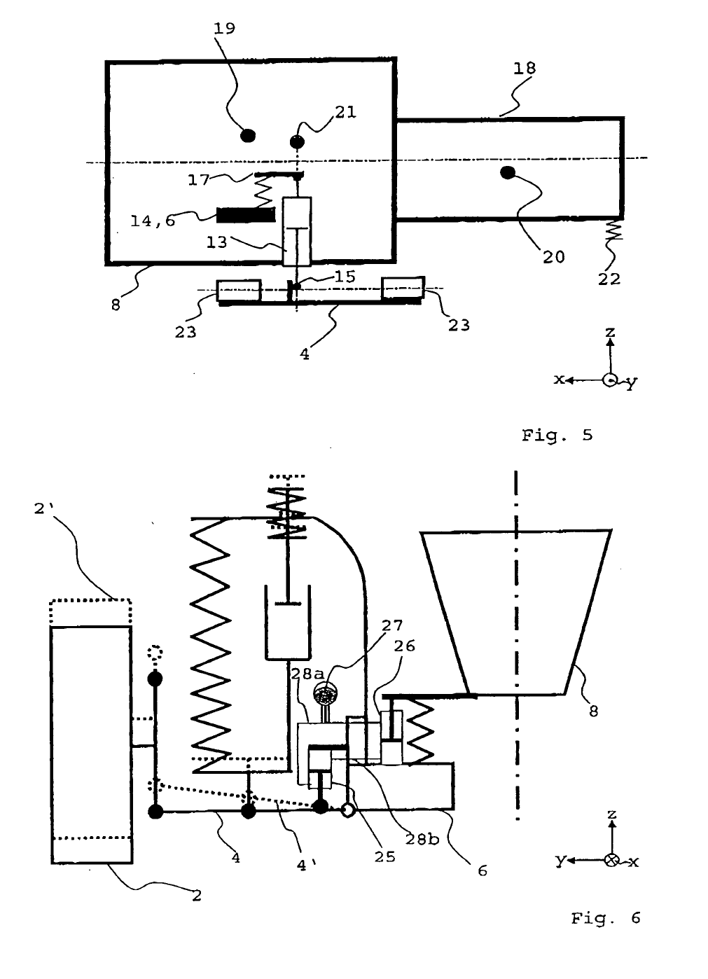

FIG. 4 is a schematic illustration of a wheel suspension arrangement as per FIG. 1 with a third embodiment of a device according to the invention,

FIG. 5 is a schematic illustration of an assembly with a coupling element in a side view,

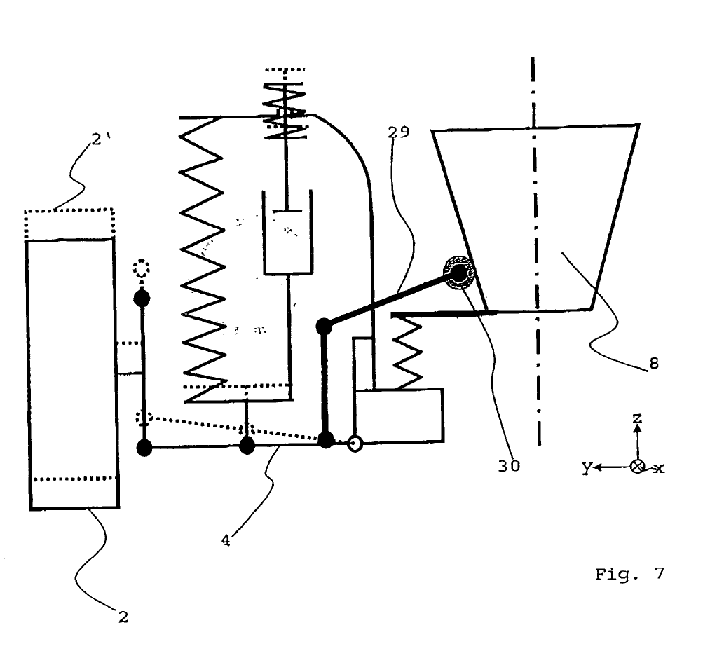

FIG. 6 is a schematic illustration of a wheel suspension arrangement as per FIG. 1 with a fourth embodiment of a device according to the invention, and

FIG. 7 is a schematic illustration of a wheel suspension arrangement as per FIG. 1 with a fifth embodiment of a device according to the invention.

Identical components in FIGS. 1 to 7 are denoted in the following with identical reference symbols.

FIG. 1 schematically illustrates a left-hand front wheel suspension arrangement which comprises a wheel carrier 1 on which a wheel 2 is mounted. For clarity, only the left-hand wheel suspension arrangement is shown; the wheel suspension arrangement on the right-hand side is of correspondingly mirror-symmetrical design. Between the wheel carrier 1 and a structure 3, an upper and a lower transverse link 4, 5 are connected to the link mounts 23. The structure comprises an integral support 6 which is connected to a body 7 in an immoveable manner. The upper and lower transverse links 4, 5 are in each case connected to the structure 3 and to the wheel carrier 1 in an articulated manner. An assembly 8, which comprises an internal combustion engine 24 with an associated bracket 17, is mounted on the integral support 6. The internal combustion engine 24 is supported by means of the bracket 17 on an engine mount 9 which conventionally has only a small damping component. However, it is possible by using hydraulically damped engine mounts 9 to adjust the damping component according to demand. A spring 10 and a damper element 11 are arranged between the lower transverse link 4 and the body 7. The damper element 11 is connected to the body 7 by means of a head mounting 12. In the same way, it is also possible for a spring-and-damper strut to be arranged between the link 4 and the body 7. The spring 10 can be embodied, for example, as an air spring or a steel spring.

The wheel 2′ which is compressed as it travels over an uneven underlying surface is represented by a dotted line. In the same way, the upper and lower links 4′, 5′ are also deflected as a result of the compression of the wheel. However, the uneven underlying surface is not completely absorbed by the wheel suspension arrangement, but rather the body 7′ and the integral support 6′ are proportionately raised. This is the case in the low-frequency range of structure vibration. In addition, the exertion of an impulse into the body 7 results in a vibration of the drive unit 8 at its natural frequency. The impulse is transmitted to the body 7 and the structure 3 primarily via the damper element. As a result of the high inertial mass of the assembly 8 and the resilient mounting relative to the integral support 6, the assembly 8 is displaced relative to the integral support 6, with the engine mount 9 compressing and the spacing between the assembly 8 and the integral support 6 being reduced from a to a′. For better clarity, the spring 10 and the damper element 11 are not shown in the compressed state.

As a result of the deflection of the assembly 8, the latter is stimulated to vibrate. Said vibrations, also referred to as juddering, of the assembly 8 are transmitted to the vehicle occupants, considerably reducing driving comfort.

FIG. 2 illustrates the wheel suspension arrangement from FIG. 1 expanded to include a coupling element 13 which is embodied as a vibration damper. The coupling element 13 is connected to the lower transverse link 4 and the bracket 17 in an articulated fashion at the linkage points 15. The linkage points 15 can be embodied, for example, as a ball-and-socket joint and/or as eye joints mounted in rubber. The mode of operation of the coupling element 13 is described in the following during wheel compression; the process takes place in a similar fashion in the reverse order as the wheel rebounds. The integral support which, as described above, is raised as the wheel is compressed, is denoted by 6′. The lower transverse link as deflected when the wheel is compressed is denoted by 4′. The coupling element 13 is supported on the assembly 8 and on the lower transverse link 4′ and is therefore subjected to compressive loading. As the wheel 2 is compressed, a force 14 acts on the assembly 8 via the coupling element, which force 14 reduces the compression of the engine mount 9. The assembly as displaced upwards as the wheel 2 is compressed is denoted by 8′. The spacing a between the assembly 8, 8′ and the integral support 6, 6′ is therefore a substantially constant variable. By suitably selecting the linkage points 15 and their degrees of elasticity and the damping characteristic curve of the coupling element 13, which if required have different tension and compression stages, it is possible to adapt said force 14 in such a way that a stimulus for the assembly 8 to vibrate does not occur or occurs to only a small extent.

The faster the wheel 2 is compressed, the faster the integral support 6 is raised and the higher the inertial force of the assembly 8 which acts on the engine mount 9. However, as a result of the vibration damper characteristic curve, the force exerted by the coupling element 13 on the assembly 8 also increases with the speed of compression of the wheel 2. At the same time, the impulse exerted into the structure 3 via the damper element 11 has an effect as the speed of compression of the wheel 2 increases. As a result of the coupling element 13 being connected to the lower transverse link 4 and the bracket 17 at the linkage points 15, however, a further impulse is exerted on the assembly 8 which reduces the effect of the impulse exerted by the damper element 11 on the assembly 8. The spacing of the assembly 8 to the integral support 6 can therefore be kept largely constant at all speeds of compression of the wheel. This also relieves the engine mount 9 of load and reduces a compression of the wheel, effectively avoiding a stimulus for the assembly 8 to vibrate.

Any compression of the wheel causes a stroke movement of the coupling element 13 and therefore a force which acts on the assembly 8. Relative movements between the assembly 8 and the body 7 or the integral support 6 cannot, however, be avoided in all operating states of a vehicle. Said relative movements are damped by the coupling element 13 embodied as a vibration damper. The damping work of the engine mount 9 is therefore advantageously assisted by the coupling element 13.

It is of course also possible in the same way to avoid a stimulus for the assembly 8 to vibrate as the wheel 2 rebounds.

FIG. 3 illustrates a modified embodiment of the device according to the invention. The coupling element 13 is arranged between the upper transverse link 5 and the assembly 8. In contrast to FIG. 2, the coupling element 13 is subjected to tensile loading as the wheel 2 compresses. The compression of the engine mount 9 is avoided in that the coupling element 13 exerts a force 14 on the assembly 8 which counteracts an inertial force. Said force seeks to maintain a constant spacing a between the assembly 8 and the integral support 6 as the wheel 2 compresses and rebounds.

FIG. 4 illustrates a device according to the invention with a chassis auxiliary frame axle. The chassis auxiliary frame 14 is mounted on the body by means of resilient chassis auxiliary frame mounts 16. On the chassis auxiliary frame 14 itself, the assembly 8 or the internal combustion engine 24 is mounted on brackets 17 by means of engine mounts 9. The lower transverse link 4 is connected to the chassis auxiliary frame 15 in an articulated fashion, and the upper transverse link is connected to the body 7. The coupling element 13 is arranged between the assembly 8 and the lower transverse link 4. The wheel which is raised as it is compressed is denoted by 2′, and the chassis auxiliary frame which is raised simultaneously is denoted by 14′. A compression of the engine mount 9 as a result of the high inertia of the assembly 8 is avoided by the coupling element 13. The coupling element exerts a force on the assembly 8, so that the latter is displaced into the position of the assembly 8′. The coupling element 13 keeps the spacing a between the assembly 8, 8′ and the chassis auxiliary frame 14, 14′ substantially constant. A stimulus for the assembly 8 to vibrate as the wheel 2 compresses and rebounds is thereby effectively counteracted.

FIG. 5 illustrates an assembly 8, which comprises an internal combustion engine 24 and a transmission 18, in a side view. The centers of gravity 19, 20 of the internal combustion engine 24 and of the transmission 18 determine a summed center of gravity 21 of the assembly 8. An engine mount 9 is arranged between the bracket 17, which is connected to the internal combustion engine 24, and the integral support 6 or chassis auxiliary frame 16. The lower transverse link 4 is rotatably mounted in the link mounts 23, and is connected to the bracket 17 by means of the coupling element 13. The central axis of the coupling element 13 is aligned so as to run through the summed center of gravity 21. During movements of the lower transverse link 4, the coupling element 13 transmits a force to the assembly 8. As a result of said force, or an impetus, acting on the summed center of gravity 21, no torque or rotational impulse is generated which would additionally load the mount such as for example a transmission mount 22. In connection with the reduced tendency to judder as a result of the coupling element 13, said arrangement also makes it possible to design the transmission mount 22 to be soft, so as to ensure good noise decoupling.

In the embodiment illustrated in FIG. 6, the coupling between the link 4 and the assembly 8 is of hydraulic design. A hydraulic master unit 25 which comprises a piston and a cylinder is arranged between the link 4 and the integral support 6, and a hydraulic slave unit 26, which likewise comprises a piston and a cylinder, is arranged between the assembly 8 and the integral support 6. The master and slave units 25, 26 are connected to one another by means of hydraulic lines 28a, b. A gas spring 27 is connected into the hydraulic line 28a which gas spring 27 acts with a constant pressure on the hydraulic fluid situated in the circuit. A gap through which hydraulic fluid can flow is provided between the piston and the cylinder of the master and/or slave units 25, 26. As a wheel compresses, the master unit 26 is shortened, and the hydraulic fluid which is compressed in the master unit 25 is at least partially displaced into the slave unit 26 depending on the gap size. The slave unit 26 exerts an impulse on the assembly 8 which, corresponding to the mode of operation in the previous embodiments, reduces juddering of the assembly 8. The coupling system can advantageously be tuned by varying the leakage gap. The slave unit 26 also serves to damp vibrations of the assembly 8. In a simplified embodiment, it is of course possible to dispense with the gas spring 2 and the hydraulic line 28a. Since said embodiment requires only the arrangement of hydraulic lines, which can be positioned as desired, between the assembly 8 and the link 4, the master and slave units 25, 26 can be arranged at a distance from one another without great expenditure without having to take into consideration a corresponding installation space for mechanical connecting elements such as bars, cylinders etc.

FIG. 7 shows an embodiment in which the coupling element is embodied as a bar 29 with a friction head 30. As the wheel 2 compresses into the position of the wheel 2′, the bar 29 moves the friction head 30, which is in frictional contact with the assembly, upward. As a result of the frictional force, an impulse is exerted on the assembly 8 which, corresponding to the mode of operation in the previous embodiments, reduces juddering of the assembly 8.

The above described devices according to the invention also advantageously damp vibrations of the assembly 8 by means of the coupling element 13 embodied as a vibration damper, considerably increasing driving comfort in particular in the case of engine mounts 9 with low damping properties. The use of a vibration damper as a coupling element 13 can therefore also make it possible to save on damping devices in the engine mount 9.

In a modified exemplary embodiment which is not illustrated, the coupling element 13 is arranged such that, as the wheel 2 compresses and rebounds, in addition to a force in the direction of the vertical axis z, a force also acts on the assembly 8 in the direction of the longitudinal axis x. It is thereby possible to avoid longitudinal vibration of the assembly 8 in the direction of the X axis. The force in the direction of the longitudinal axis x can be obtained by means of an arrangement of the coupling element 13 as in FIGS. 2-4, rotated about the transverse axis y. The magnitude of the force acting on the assembly 8 in the direction of the longitudinal axis x can be adjusted by means of the magnitude of the rotational angle.

### List of Reference Symbols

1 Wheel carrier
2 Wheel
2′ Compressed wheel
3 Structure
4 Lower transverse link
4′ Deflected lower transverse link
5 Upper transverse link
5′ St Deflected upper transverse link
6 Integral support
6′ Raised integral support
7 Body
7′ Raised body
8 Assembly
8′ Displaced assembly
9 Engine mount
10 Spring
11 Damper element
12 Head mounting
13 Coupling element
14 Chassis auxiliary frame
14′ Raised chassis auxiliary frame
15 Linkage points
16 Chassis auxiliary frame mount
17 Bracket
18 Transmission
19 Center of gravity, internal combustion engine
20 Center of gravity, transmission
21 Summed center of gravity
22 Transmission mount
23 Link mount
24 Internal combustion engine
25 Master unit
26 Slave unit
27 Gas spring
28a Hydraulic line
28b Hydraulic line
29 Bar
30 Friction head

1. device for damping vibrations in a motor vehicle, having
a structure on which an assembly is resiliently mounted, and
a wheel carrier which supports a wheel and is connected to the structure in an articulated fashion by means of links,
characterized in that a coupling element (13) is arranged between one of the links (4, 5) and the assembly (8).

2. The device as claimed in claim 1, characterized in that the structure (3) comprises a support (6), on which the assembly (8) is mounted, and a body (7).

3. The device as claimed in claim 2, characterized in that the support (6) is connected to the body (7) in an immoveable manner.

4. The device as claimed in claim 2, characterized in that the support (14) is connected to the body (7) in a moveable manner by means of mounts.

5. The device as claimed in claim 1,
characterized in that the coupling element (13) is embodied as a rigid rod.

6. The device as claimed in claim 1,
characterized in that the coupling element (13) is embodied as a vibration damper.

7. The device as claimed in claim 2,
characterized in that the coupling element (13) is connected to a link (4, 5) which is mounted on the body.

8. The device as claimed in claim 2,
characterized in that the coupling element (13) is connected to a link which is mounted on the support (6, 14).

9. The device as claimed in claim 1,
characterized in that the coupling element (13) is connected to a link which is embodied as a stabilizer rod.

10. The device as claimed in claim 1,
characterized in that the coupling element (13) exerts a force on the assembly (8) in the direction of the vehicle vertical axis z during movements of the link.

11. The device as claimed in claim 1,
characterized in that the coupling element (13) exerts a force on the assembly (8) in the direction of the longitudinal axis x during movements of the link.

12. The device as claimed in claim 1,
characterized in that the coupling element (13) exerts a force on the assembly (8) in the transverse axis y during movements of the link.

13. The device as claimed in claim 1,
characterized in that the longitudinal axis of the coupling element (13) runs through the center of gravity of the assembly (8).
